(19) United States
(12) Patent Application Publication
(10) Pub. No.: US 2026/0038851 A1
(43) Pub. Date: Feb. 5, 2026

(54) FUEL CELL

(71) Applicant: KAMAX Holding GmbH & Co. KG, Homberg (Ohm) (DE)

(72) Inventors: Dennis Dutenhöfner, Homberg (Ohm) (DE); Johannes Schwalm, Bingen (DE); Claudia Pöggeler Ribas, Marburg (DE); Alexander Hochgesand, Bad Nauheim, Steinfurth (DE); Stefan Wallmeier, Goldbach (DE)

(73) Assignee: KAMAX Holding GmbH & Co. KG, Homberg (Ohm) (DE)

(21) Appl. No.: 18/998,883

(22) PCT Filed: Jul. 11, 2023
(86) PCT No.: PCT/EP2023/069181

§ 371 Date: Jan. 27, 2025

(30) Foreign Application Priority Data
Jul. 29, 2022 (DE) 102022119087.0
Nov. 29, 2022 (DE) 102022131561.4
Nov. 29, 2022 (DE) 102022131562.2

(51) Int. Cl. H01M 8/0297

(52) U.S. Cl. CPC H01M 8/0297

(57) ABSTRACT

Fuel cell (1) comprising a bipolar plate (210), in particular a plurality of bipolar plates (210), and/or comprising a connecting means (9), in particular a plurality of connecting means (9), wherein the bipolar plate (210) extends in a longitudinal direction (L) and in a width direction (B), wherein the longitudinal direction (L) and the width direction (B) are in particular perpendicular to one another, wherein the bipolar plate (210) has a plurality of apertures (240), wherein the apertures (240) have an outer contour, wherein the outer contour of the apertures (240) is formed in particular in each case by a mounting aperture (242) and at least one flow aperture (244), wherein the mounting aperture (242) advantageously forms a circular segment-shaped part of the outer contour of the aperture (240), and wherein the mounting aperture (242) or the aperture (240) is designed to receive the or a connecting means (9).

### CROSS-REFERENCE TO RELATED APPLICATIONS

This application is a U.S. National Stage Application under 35 U.S.C. § 371 of International Application No. PCT/EP2023/069181, filed Jul. 11, 2023, which claims the benefit of and priority to German Patent Application Nos. DE 10 2022 119 087.0, filed Jul. 29, 2022, DE 10 2022 131 562.2, filed Nov. 29, 2022, and DE 2022 131 561.4, filed Nov. 29, 2022, the contents of which are hereby incorporated herein by reference in their entireties.

### TECHNICAL FIELD

The invention relates to a fuel cell.

### BACKGROUND

Fuel cells are already known from the prior art. These are used to release electrons, in particular by using a reaction, in order to generate a current flow or provide energy. Various fluids can be used as fuel, e.g. hydrogen. However, the problem with the known systems is that the fuel cells consist of several cells, which are separated from each other by bipolar plates. These cells are usually arranged in stacks and covered at the ends by an end plate in order to achieve a compact design. The cells are usually fixed to each other and to the end plate by an external connecting means. However, this exposes the bipolar plates and the end plate to large bending stresses and/or results in a high installation space requirement.

### SUMMARY

It is therefore the object of the invention to provide a space-saving arrangement which nevertheless enables the components of the fuel cell to be securely fixed.

This object is solved with a fuel cell according to claim 1 and with a use according to claim 15. Further advantages, features and embodiments are shown in the subclaims, the description and the figures.

A fuel cell according to the invention. The fuel cell comprises in particular a bipolar plate, in particular a plurality of bipolar plates, and/or comprises in particular a connecting means, in particular a plurality of connecting means, wherein the bipolar plate extends in a longitudinal direction and in a width direction, wherein the longitudinal direction and the width direction are in particular perpendicular to one another, wherein the bipolar plate has a plurality of apertures, wherein the apertures have an outer contour, wherein the outer contour of the apertures is formed in particular in each case by a mounting aperture and at least one flow aperture, wherein the mounting aperture advantageously forms a circular segment-shaped part of the outer contour of the aperture, and wherein the mounting aperture or the aperture or one of the apertures is designed to receive the or a connecting means. The fuel cell is used to convert energy from one form, usually chemically bound, into another form, in particular electrical energy. The fuel cell has bipolar plates and/or connecting means. The connecting means will be explained in more detail below. However, it is important that advantageously at least one connecting means, preferably a plurality of connecting means, and most preferably all connecting means, extend through the bipolar plates or through the apertures of some or all of the bipolar plates. In other words, the bipolar plate or some of the bipolar plates surround or enclose the connecting means. This allows a particularly compact arrangement to be created. The bipolar plate serves to form or can form part of a fuel cell. The bipolar plate extends in a longitudinal direction and in a width direction, wherein the longitudinal direction and the width direction are in particular perpendicular to one another, wherein the bipolar plate has a plurality of apertures, wherein the apertures have an outer contour, wherein the outer contour of the apertures is formed in each case by a mounting aperture and at least one flow aperture, wherein the mounting aperture forms a circular segment-shaped part of the outer contour of the aperture, and wherein the mounting aperture is designed to receive a connecting means. The bipolar plate is a part and/or can be arranged or used in a fuel cell. In particular, an MEA is arranged in each case between two bipolar plates. An MEA is to be understood as a membrane electrode mounting in the sense of the invention. The bipolar plates therefore serve to be able to conduct fuel, in particular hydrogen, and/or oxygen and/or combustion products, in particular fluids, e.g. water or water vapor, from and/or to the MEA and at the same time to at least partially limit the intake volume for the MEA. Furthermore, the bipolar plates can be used in particular to conduct electrons. In particular, the bipolar plates are formed, at least partially, from a conductive material and/or from plastic and/or at least in part from an insulating material. The bipolar plates can therefore in particular form part of a stack or a “bag” of a fuel cell. The bipolar plates extend in particular in a longitudinal direction and in a width direction. The longitudinal direction is in particular the direction in which the bipolar plate has its largest main dimension. The width direction, on the other hand, can in particular be the direction in which the width of the bipolar plate is measured. A height direction can be perpendicular to the longitudinal direction and/or the width direction. In particular, the height direction can be the direction in which the material thickness of the bipolar plate is measured. It is particularly expedient for the longitudinal direction and the width direction to be perpendicular to each other. Furthermore, the longitudinal direction, the width direction and the height direction can preferably be perpendicular to each other. In other words, the longitudinal direction, the width direction and the height direction can form a right-angled coordinate system with each other. The bipolar plate comprises a large number of apertures. In particular, these apertures penetrate the bipolar plate completely, wherein the main direction of extension of the apertures is in particular the height direction. In other words, the apertures can penetrate the bipolar plate in the height direction. This makes it possible to guide means, in particular connecting means, and/or fluids through the bipolar plate. In other words, the apertures can therefore serve to allow a fluid to flow from one side of the bipolar plate to the other side of the bipolar plate and also simultaneously provide a receiving space for a fastening, connecting or tensioning means. Advantageously, the connecting means are thus tensioning means, i.e. means that provide or can provide tensioning of the bipolar plates relative to one another. In the context of the invention, the connecting means can also be fastening means or be designated as such. In particular, the flow apertures of the apertures are intended for the fluid conduit. The apertures themselves are formed by a component, which is the flow aperture, and at least also by a further component, which is referred to as the mounting aperture. The mounting aperture serves to accommodate a or the connecting means, which can also be a tensioning means, in order to enable the bipolar plate and/or the stacks of the fuel cell to be tensioned. In other words, the aperture can therefore be formed by a combination of a mounting aperture and at least one flow aperture. It is expedient for the bipolar plate to have a large number of apertures, each of which has at least one flow aperture and one mounting aperture. The apertures are arranged or formed in such a way that they form an outer contour on the bipolar plate. The outer contour is in particular the outer edge of the aperture on a surface bordering the bipolar plate, in particular in the height direction. This outer contour of the aperture or apertures is formed at least in sections by the flow aperture and at least in sections by the mounting aperture. In other words, the edge of the aperture is formed at least in part by the mounting aperture and at least in part by the flow aperture. In particular, the mounting aperture forms a circular segment-shaped part of the outer contour of the aperture. In other words, at least part of the outer aperture is therefore formed by a circular section, which at the same time also delimits the mounting aperture. Alternatively, the aperture can thus have a section in the shape of a semi-circular segment, which is formed just through the mounting aperture. In this way, a particularly low notch effect factor and favourable in production costs as well as compact design of the mounting aperture can be achieved, in particular adapted to a connecting means, in particular a connecting means in the form of a screw. A screw within the meaning of the invention can in particular be a connecting means which has an actuating head and/or an actuating section and furthermore has an external thread and/or an internal thread, which in particular is introduced into a shaft section.

In a preferred embodiment, the bipolar plate has a flow region, wherein the flow region, in particular later, serves to delimit a fluid volume, wherein the fluid volume is or can be in fluid connection with at least two apertures. The flow region is in particular that region of the bipolar plate, or the outer surface or surfaces of the bipolar plate bordering in the height direction, which is or can later be brought into fluid contact with the MEA. The flow region can therefore form or be or comprise a surface on the bipolar plate. The bipolar plate has both a flow region, which is formed by a surface bordering in the positive height direction, and a flow region, which is formed by a surface bordering in the negative height direction. The flow region serves in particular later to limit the fluid volume which is in communication with the MEA and/or to at least partially provide the volume in which the

MEA is arranged. The flow region therefore borders a fluid volume in particular, which is or can be in fluid communication with at least two apertures in the bipolar plate. This can be particularly decisive if a sealing element is later arranged and/or is arranged on the bipolar plate, which allows a fluid flow from the aperture to the flow region and from the flow region to another aperture. In this way, the apertures, in particular the flow inlets of the apertures, which are in fluid connection with the flow region or the fluid volume, can be used to achieve an inflow and outflow of fluids into the fluid volume.

Expediently, the mounting aperture and the flow aperture of an aperture or the apertures penetrate the bipolar plate. This makes it particularly easy to feed a connecting means and a flow fluid through the bipolar plate.

Advantageously, the flow aperture is designed in such a way that it extends from the mounting aperture to the flow region in the plane defined by the longitudinal and width directions. This makes it possible to achieve a particularly aerodynamically favorable design of the flow aperture.

Expediently, the circular segment-shaped part of the mounting aperture forms at least 51%, preferably at least 65%, and particularly preferably at least 75%, of a circle. In other words, the circular segment-shaped part can form at least 51% of a complete circle, preferably at least 65% of a complete circle, and particularly preferably at least 75% of a complete circle. By designing the mounting aperture in such a way that at least 51% is formed by the circular segment-shaped part of the mounting aperture, it is possible to secure the position of the connecting means accommodated in the circular segment-shaped part or in the mounting aperture. In other words, such a design can in particular ensure a positive locking of a connecting means within the mounting aperture or at least provide it in an emergency, so that in particular a slipping of the bipolar plate in relation to the connecting means in a longitudinal direction and width direction plane is prevented or can be prevented in a positive locking manner. To further improve this positive locking, the circular segment-shaped part should form at least 65%, preferably at least 75% of a complete circle. In this way, the positive locking between the bipolar plate and a connecting means can be further improved in order to achieve a better accuracy of the positional locking. This type of positive locking of the bipolar plate relative to the connecting means makes it particularly easy to assemble. In particular, this makes it possible to thread the individual bipolar plates onto the connecting means at a later stage, simplifying mounting.

Preferably, however, the circular segment-shaped part of the mounting aperture forms a maximum of 98%, preferably a maximum of 90%, and particularly preferably a maximum of 80%, of a circle. The parts that are missing in order to form the complete circle belong in particular to the flow aperture. In other words, such a design can therefore ensure that there is sufficient space for the flow aperture in the aperture so that a sufficient flow surface or flow possibility is provided.

Preferably, the bipolar plate has flow grooves, in particular in one or the flow

region of the bipolar plate, wherein the flow grooves end and/or start in particular in an aperture. In other words, the bipolar plate can have grooves, in particular in a surface which delimits the bipolar plate in the height direction, which can promote and/or achieve a fluid flow. These grooves are called flow grooves in particular. Expediently, these flow grooves run on the bipolar plate or are arranged on the bipolar plate in such a way that they end and/or start in an aperture, in particular in a flow aperture. In other words, the grooves extend into the flow aperture or the aperture. This allows a particularly fluidically favourable connection of the flow grooves to be achieved. By providing the flow grooves, clogging and a uniform supply of fluids into the MEA can also be achieved in particular.

In a preferred embodiment, the flow grooves are formed by straight and/or rectangular sections and/or the flow grooves are meandering. By using only straight and/or rectangular or right-angled sections and/or with a meandering design, the flow groove has a particularly large extension. This enables a particularly effective and homogeneous supply of fluids and/or discharge of fluids into and/or out of the MEA into the flow grooves. Due to the meandering design of the flow groove, a particularly long flow length of the grooves can also be achieved and thus a particularly homogeneous supply or discharge of fluids from and/or into the MEA.

Advantageously, the part of the outer contour of the aperture formed by the flow aperture is further away from the center of gravity of the aperture or from the center of the circular segment-shaped part than the part of the outer contour of the aperture formed by the mounting aperture. In other words, the flow aperture may extend away from the otherwise circular mounting aperture like an extension. Alternatively or additionally preferably, the mounting aperture forms all circular segment-shaped parts of the aperture and/or is formed exclusively by circular segment-shaped parts, which in particular all have the same center point. These types of design of the aperture, some of the apertures, the majority of the apertures and/or all of the apertures can create a particularly good fluid routing option. The center of the circular segment-shaped part is in particular the point around which the radius of the circular segment-shaped part is determined or the point which has the same distance to all points of the circular segment-shaped part.

Preferably, the bipolar plate has a width to length ratio of in particular less than or equal to 1 to 3, wherein the bipolar plate has an aperture, in particular a plurality of apertures, in its central area in the longitudinal direction. In other words, the dimension of the bipolar plate in the width direction may be in a ratio of less than or equal to 1 to 3 to the dimension of the bipolar plate in the length direction. If such a ratio is present, an aperture, in particular a plurality of apertures, may be provided in a central area in the longitudinal direction. The central area in the longitudinal direction is in particular that area of the bipolar plate in the longitudinal direction which extends in the longitudinal direction from the ideal center point +/−25%, preferably +/−15%, and particularly preferably +/−10%, and particularly strongly preferably +/−5%, of the maximum length of the bipolar plate in the longitudinal direction. The center of the bipolar plate is in particular the center of volume or the center of gravity of the bipolar plate. The arrangement of an aperture, in particular a plurality of apertures, as also described above and below, in the center area enables particularly good tensioning of the bipolar plate. In particular, bending moments due to the tension can be avoided or reduced by the arrangement of an aperture in the central area. Advantageously, all these apertures are designed as described above or below, in particular the apertures therefore have mounting apertures and flow apertures, wherein a connecting means is or can be guided through the flow aperture in particular.

Advantageously, the fuel cell comprises a sealing element, in particular a sealing ring. It is expedient for the sealing element to lie against the bipolar plate, wherein the sealing element follows or can follow the circular segment-shaped part of the outer contour of an aperture, at least in sections. The fuel cell therefore comprises in particular at least one sealing element, which can be designed as a sealing ring. A sealing ring is to be understood as a sealing element which is self-contained. In other words, the sealing ring is therefore a sealing element without an end. In particular, the sealing element is in contact with the bipolar plate: this can be achieved in particular by direct contact between the sealing element and the bipolar plate. Expediently, this contact or contact area of the sealing element with the bipolar plate forms a closed contour. In other words, the sealing element can therefore always be in contact with the bipolar plate along its extension. Expediently, the sealing element follows, at least in sections, the or a circular segment-shaped part of the outer contour of an aperture. The following is to be understood in particular as meaning that the projection of the sealing element and the projection of the outer contour onto a plane which is spanned by the longitudinal direction and the width direction overlap or overlap and/or that the course of the sealing element and the outer contour is the same at least in the following area and/or the sealing element abuts the circular segment-shaped part of the outer contour at least in sections. This following of the sealing element in the circular segment-shaped circle of the outer contour of the aperture makes it possible, in particular, to achieve a particularly short length of the sealing element and also a high sealing effect.

In an advantageous embodiment, the sealing element follows at least 40%, preferably at least 60%, and particularly preferably at least 80%, and particularly strongly preferably at least 90%, and very particularly strongly preferably at least 97%, of the circular segment-shaped part of the outer contour of an aperture. Alternatively or additionally preferably, the sealing element follows at least 40%, preferably at least 60%, and particularly preferably at least 80%, and particularly strongly preferably at least 90%, and very particularly strongly preferably at least 97%, of the outer contour of an aperture. By following at least 40% of the circular segment-shaped part and/or the entire outer contour of the aperture, a particularly simple mounting can be achieved. If, on the other hand, at least 60% or at least 80% of the circular segment-shaped part of the outer contour and/or the entire outer contour of the aperture is followed by the sealing element, a particularly good sealing effect can be achieved. If, on the other hand, 90% of the outer contour or the circular part is followed by the sealing element, a particularly good mechanical support capability can be achieved around the aperture. This ability is particularly noteworthy because when the bipolar plate is braced by means of a fastening or connecting means that is guided through the aperture, contact forces or tensioning forces can be safely dissipated directly via the sealing element. At least X percent following the circular segment-shaped part of the outer contour of the aperture or the outer contour of the aperture means in particular that at least X percent of the projection of the outer contour of the circular segment-shaped part or the entire outer contour onto a plane that is spanned by the longitudinal and width directions overlaps with the projection of the sealing element in this plane and/or that the sealing element is in contact with at least X percent of the circular segment-shaped part of the outer contour or the outer contour.

Advantageously, the sealing element protrudes into the or one aperture and/or protrudes into at least two apertures. In particular, only the apertures that have a mounting aperture and a flow aperture and/or through which a connecting means is guided and/or which serve or are designed to receive a connecting means are relevant. By protruding inwards, it can be achieved in particular that the seal can be arranged between the connecting means and the edge of an aperture so that contact between the connecting means and the aperture is prevented. In other words, the sealing element can therefore be used to create electronic insulation between the connecting means and the bipolar plate.

Expediently, the sealing element is made of an insulating material in particular.

Advantageously, the fuel cell has a plurality of sealing elements, wherein the sealing elements follow the course of the outer contour of at least one aperture, at least in sections, and/or wherein each aperture is surrounded by an outer contour of a sealing element. Particularly relevant for this are those apertures which have a mounting aperture and a flow aperture and/or which are designed to accommodate a connecting means. By forming such that the apertures and/or at least one of the apertures is surrounded by an outer contour of a sealing element, it can be achieved that the aperture can be used to guide fluid into and/or out of a fluid volume. Surrounding the aperture by an outer contour of a sealing element means, in particular, that in a projection onto the plane, which is formed by the longitudinal direction and the width direction, of the surrounding sealing element and the aperture, the outer contour of the projection of the sealing element or the outer edge of this contour surrounds and/or contains the outer contour of the aperture.

Preferably, the sealing element is fixed to the bipolar plate, in particular in a materially bonded and/or irreversible manner, and/or the sealing element is produced by a screen printing process. The advantage of using a screen printing process lies in particular in the cost-effective production of the sealing element. By fixing the sealing element to the bipolar plate, simple mounting of the fuel cell can be achieved in particular. In order to achieve this fixation, the sealing element is in particular made materially bonded, for example by gluing and/or by a screen printing process. Expediently, the sealing element is irreversibly fixed to the bipolar plate so that the connection between the sealing element and the bipolar plate can only be achieved by destroying the connection. This enables a particularly high sealing effect to be achieved.

Advantageously, the sealing element is arranged on the bipolar plate in such a way that the sealing element forms a closed contour on the bipolar plate, wherein at least two flow apertures, in particular of different apertures, and/or the flow region of the bipolar plate is or are advantageously arranged within the closed contour. By providing a closed contour of the sealing element on the bipolar plate, a particularly high sealing effect can be achieved. By arranging at least two flow apertures within the closed contour, a particularly good supply and discharge of fluids into the sealed area can be achieved. In particular, the flow region of the bipolar plate and/or at least the outlet or the contour of flow apertures, in particular of different apertures, is also arranged within this sealed area or within the closed contour. In this way, a particularly homogeneous or targeted supply and removal of fluids into the flow region of the bipolar plate can be achieved.

In a preferred embodiment, the fuel cell comprises a connecting means, wherein the connecting means is guided through the aperture, in particular through the mounting aperture of the aperture, wherein the connecting means in particular contacts the sealing element. The contact between the sealing element and the connecting means can provide insulation between the connecting means and the bipolar plate. By passing the connecting means through an aperture, in particular through the mounting aperture of the aperture, a particularly simple and space-saving clamping and mounting option for the bipolar plate can be achieved.

Expediently, the connecting means has an actuating area, in particular a head, and a mounting area, wherein the mounting area forms a thread. Expediently, the mounting area is formed in and/or around a shaft area of the connecting means. The connecting means extends in particular in the height direction. In other words, the main direction of extension of the connecting means is therefore advantageously formed parallel to the height direction. Particularly preferably, a connecting means is guided through each aperture in the bipolar plate, which has a mounting aperture and a flow aperture. This allows a particularly homogeneous tensioning of the bipolar plate to be achieved.

In a preferred embodiment, the connecting means has a flow passage extending along a height direction or the height direction, wherein the flow passage is in fluid connection with the flow aperture, which co-forms the aperture through which the connecting means is guided. The flow passage can be a central recess or the central recess can be a flow passage. For example, the connecting means can be a banjo, wherein a flow passage can be formed within the banjo. Alternatively preferably, the flow passage can also be formed externally in the connecting means, for example by means of an external groove. The flow passage extends in particular in the height direction. In other words, the flow passage can therefore provide fluid conveyance capability in the height direction. This flow passage of the connecting means is in particular in fluid connection with the flow aperture, so that a fluid can flow from the flow passage into the flow aperture. This can provide a particularly effective flow option. The flow passage can be realized in particular by means of a/the central recess of the connecting means.

In an alternative or additionally preferred embodiment, the fuel cell comprises a plurality of connecting means, wherein the plurality of connecting means are each guided through an aperture, wherein this aperture has, in particular, a mounting aperture and/or a flow aperture. In this way, a particularly homogeneous stress force distribution can be achieved, so that ultimately a particularly high density effect can be achieved, but at the same time valuable installation space can be saved.

Advantageously, the fuel cell comprises an end plate, wherein the end plate extends in a longitudinal direction or the longitudinal direction and a width direction or the width direction, wherein the end plate has two tensioning area, in particular spaced apart from one another in the longitudinal direction, wherein the bending stiffness of the end plate, in particular between the tensioning areas, is variable, advantageously decreasing in the direction towards the tensioning areas. The end plate extends in particular in a longitudinal direction and a width direction, wherein the longitudinal direction of the end plate can correspond to the longitudinal direction as described above and below and/or the width direction can correspond to the width direction as described above and below. The longitudinal direction of the end plate is in particular the direction in which the end plate has its largest main dimension and/or in which the length of the end plate is determined. The width direction, on the other hand, is in particular the direction in which the width of the end plate is determined and/or in which the end plate has its second largest main dimension. The longitudinal direction and the width direction can in particular be perpendicular to a height direction: in particular, this height direction is parallel and/or congruent with the height direction already described above and/or below. The end plate serves in particular to be arranged in a fuel cell and to form a distal end of the fuel cell, in particular in the height direction. In order to achieve mounting of the end plate, it has in particular two tensioning areas that are spaced apart from one another. The tensioning areas are in particular areas which serve to provide a force transmission to the end plate. An area in which the end plate has a variable bending stiffness is expediently provided between these two tensioning areas. In particular, this area with variable bending stiffness is extended in such a way that it comprises and/or forms a central area in the longitudinal direction of the end plate. The central area of the end plate is determined in the same way as the central area of the bipolar plate. Expediently, the bending stiffness of the area located between the tensioning areas is designed in such a way that its bending stiffness decreases in the direction of the tensioning areas. Therefore, the bending stiffness is greatest in the area furthest away in the longitudinal direction towards the tensioning areas. Basically, the end plate can also be referred to as a head plate in the sense of the invention.

In an advantageous embodiment, the end plate has curved stiffening ribs, with the curved stiffening ribs extending in particular parallel to the longitudinal direction. Expediently, these curved stiffening ribs have a variable height in the longitudinal direction. In particular, the curved stiffening ribs are designed in such a way that they have the largest main dimension parallel to the longitudinal direction in order to provide particularly good bending stress absorption.

Expediently, the end plate, in particular the tensioning areas of the end plate, has fastening apertures. Particularly preferably, the connecting means extend through these fastening apertures, wherein the connecting means can in particular also extend through the or some of the apertures of the bipolar plates.

Advantageously, the connecting means is in particular a screw or a bolt.

Advantageously, the connecting means comprises an actuating area, in particular a head, an elasticity region and preferably a mounting area, wherein the connecting means extends in a direction of progression, wherein a radial direction is in particular perpendicular to the direction of progression, wherein the elasticity region can lie between the actuating area and the mounting area in the direction of progression, wherein the mounting area has a thread, in particular an internal thread, wherein advantageously or optionally the elasticity region and/or the mounting area are or can be hollow on the inside, and/or wherein the elasticity region has a lower elasticity than the mounting area and/or than the actuating area due to its geometry. The connecting means is used in particular to connect different components to one another, especially in a force-fit manner. This force-fitting connection relates in particular to transverse forces, advantageously in the radial direction or parallel to this direction. In order to be able to establish or transmit a transverse force, in particular perpendicular to the direction of progression, between the components to be connected, the connecting means is therefore advantageously designed as a force-fitting connecting means. In particular, the connecting means has an actuating area. The actuating area is advantageously used to apply an mounting torque to the connecting means, in particular in a form-fit manner. For this purpose, the actuating area can have actuating surfaces, in particular in the form of an external hexagon, internal hexagon, external or internal hexalobular, a multi-tooth and/or a multi-round, in each case advantageously as an internal and/or external actuation. Expediently, the normal lines of the actuating surfaces point in the radial direction. These actuating surfaces can be part of a head, which in turn can form the actuating area. In other words, the actuating area can therefore be formed by a head or comprise a head. Expediently, the actuating area is formed in such a way that it forms a distal end of the connecting means in the direction of progression. The direction of progression is in particular the direction in which the connecting means has its largest main dimension. For example, the direction of progression can therefore or alternatively preferably be the direction in which the length of the connecting means is measured. In particular, the direction of progression is parallel to the height direction. The center of gravity of the connecting means, the elasticity region and/or the mounting area can lie on the direction of progression. In particular, one or the radial direction extends perpendicular to the direction of progression. Advantageously, the direction of progression, the radial direction and a circumferential direction form a cylindrical coordinate system with one another. In particular, the direction of progression is parallel and/or congruent with the height direction. The radial direction can be parallel to the width direction and/or the direction of progression. In addition to the actuating area, the connecting means also has an elasticity region and/or a mounting area. The mounting area of the connecting means has a thread in order to form a connection with another thread, in particular a nut thread. This thread can advantageously be designed as an internal thread in order to achieve a particularly space-saving configuration. Alternatively or additionally preferred, the thread of the mounting area can also be an external thread. This makes it particularly easy to manufacture. The thread itself can in turn be a metric or imperial thread. Preferably, the mounting area is limited in the direction of progression by the distal ends of the thread in the direction of progression. Advantageously, the mounting area forms a distal end of the connecting means in the direction of progression. The mounting area, which has the thread and/or which is formed by the thread, can delimit the connecting means in the direction of progression. In order to reduce the risk of injury during mounting. the mounting area can be limited by a cylindrical surface facing outwards in the radial direction and/or have such a surface. The elasticity region lies between the actuating area and the mounting area when viewed in the direction of progression. Advantageously, the length of the elasticity region in the direction of progression is greater than the length of the actuating area and/or the mounting area in the direction of progression. In particular, the lengths of all areas are measured in the direction of progression. Expediently, the length of the elasticity region in the direction of progression is greater than the sum of the lengths of the actuating area and the mounting area. Advantageously, at least 30%, preferably at least 60% and particularly preferably at least 70% of the length of the connecting means in the direction of progression is formed by the elasticity region. The elasticity region and/or the mounting area are in particular hollow on the inside in order to create or provide easy mounting and/or a gas passage and/or a reduction in elasticity. Due to its geometry, the elasticity region is designed such that it has a lower elasticity than the mounting area and/or, wherein the elasticity region has deformation structures and/or stiffness reduction structures, in particular in the form of deformation structures. In other words, in particular the geometry of the elasticity region is such that this results in a lower elasticity in the mounting area than the elasticity in the mounting area and/or in the actuating area. The elasticity itself is in particular the spring stiffness or the gradient of the force-path diagram. The elasticity is measured in the direction of the direction of progression. In particular, this force-path diagram or the spring stiffness is not de-dimensionalized by a geometric parameter. In other words, the elasticity or spring stiffness is therefore not determined by the gradient of the stress-strain diagram but by the force actually applied to the elasticity region in comparison to the resulting displacement or the resulting deformation. The force-path diagram is therefore the force that must be applied to separate the mounting area from the actuating area in the direction of progression, while at the same time recording the resulting displacement of the actuating area in the direction of progression to the mounting area. Advantageously, the elasticity region and the mounting area and/or the elasticity region and the actuating area are made of the same material and/or in one piece. This enables particularly good mechanical durability to be achieved. Due to the lower elasticity of the elasticity region—due to the geometry in the elasticity region and/or due to the stiffness reduction structures—a load—due to a swelling and/or statically occurring expansion of the components to be connected—can be reduced. In particular, this can reduce the load on the connecting means and/or on the components to be clamped or braced, so that the operational safety and the durability of the connecting means can be increased. A further advantage of such a design is that the dynamic loads on the connecting means are also reduced.

Advantageously, the elasticity region has one or a plurality of deformation structures which are or will be subjected to bending and/or torsion when the actuating area is displaced in the direction of progression in relation to the mounting area. Deformation structures are in particular spirals or beam segments, which can be achieved, for example, by introducing recesses and/or apertures or other stiffness reduction structures into the elasticity region, in particular in the radial direction. These deformation structures are therefore in particular not recesses, but areas of material that are mechanically stressed due to the change in length in the direction of progression of the elasticity region, in particular due to a displacement of the mounting area in the direction of progression in relation to the actuating area. This mechanical stress on the deformation structures is in particular or comprises in particular a bending load and/or a torsional load. This type of loading is in particular the predominant type of loading, therefore in particular the type of loading that causes at least 30%, preferably at least 50% and particularly preferably at least 70%, of the comparative stress, in particular when applying the shape change hypothesis (von Mises) and/or the principal normal stress hypothesis (Rankine). In particular, this can increase the achievable reversible degrees of deformation of the deformation structures, so that ultimately the elasticity of the elasticity region can be reduced. In other words, the spring stiffness of the elasticity region, which can be a synonym for elasticity, can therefore be reduced by using deformation structures which are subjected to bending and/or torsion when the actuating area is displaced in the direction of progression in relation to the mounting area. In this way, a particularly advantageous design of the elasticity region can be achieved.

Advantageously, the elasticity region is designed in such a way that it has a degressive spring characteristic. In other words, the elasticity or the spring stiffness of the elasticity region-with regard to a displacement of the actuating area in the direction of progression in relation to the mounting area-can therefore be such that the elasticity is reduced or decreases with increasing spacing of the actuating area in the direction of progression in relation to the mounting area. This allows the dynamic loads to be further reduced with increasing expansion of the components to be connected or the resulting (static) load to increase less sharply. Advantageously, the spring characteristic is degressive in the elastic region. In other words, a degressive spring characteristic is achieved “before” irreversible deformation occurs. In particular, this can minimize and/or reduce permanent stress relief and/or mechanical overstressing of the components to be connected and/or the connecting means.

Advantageously, the elasticity region has one or a plurality of stiffness reduction structures, in particular recesses and/or apertures, wherein the stiffness reduction structures form or delimit the deformation structures. In other words, depressions and/or other stiffness reduction structures can be formed in the elasticity region, in particular in the radial direction, which in each case border the deformation structures. In particular, these depressions can be formed in such a way that they allow fluid to pass from the surroundings via the recess or depression or aperture into the internal hollow region or the entirely internal hollow elasticity region. In other words, the aperture or apertures can be designed in such a way that they extend from the outside into the hollow interior of the elasticity region.

The internally hollow area of the connecting means can be formed in particular by a central recess, which extends from the mounting area to the elasticity region or even to the actuating area in the direction of progression. By providing such a central recess, a fluid flow can therefore also be realized between the individual areas of the connecting means in the direction of progression.

Advantageously, the stiffness reduction structures, in particular in the form of a recess or recesses, combine an outer wall of the elasticity region with an inner wall of the elasticity region. The outer wall of the elasticity region borders it outwards, in particular in the positive radial direction, and the inner wall borders the elasticity region, in particular inwards towards the direction of progression. In particular, this inner wall can border and/or partially form the central recess. In this way, a fluid flow can be achieved in a particularly effective and direct manner from the surroundings into the internally hollow area of the elasticity region—as already explained.

Expediently, at least one stiffness reduction structure, in particular in the form of a recess, is designed in such a way that its projection in the direction of progression covers itself. In other words, at least one recess can be designed in such a way that when this recess is projected onto a plane perpendicular to the direction of progression, the projection is closed in on itself and can therefore in particular form a ring around the direction of progression. This allows a particularly high degree of elasticity reduction to be achieved, resulting in a particularly advantageous elasticity region. Advantageously, however, the ends of the recess forming the projection, which is self-covering or self-contained, are located at different height positions in the direction of progression. In other words, the recess, which may in particular be an aperture, is only closed in itself in the projection and not when the recess is viewed taking into account the extension in the direction of progression. In particular, this can prevent a drastic weakening of the connecting means.

Advantageously, the elasticity region has one or more helical recesses, in particular apertures, and/or stiffness reduction structures, so that the elasticity region has one or more and/or multi-start deformation structures which is and/or are a spiral. By providing spiral-shaped recesses and/or stiffness reduction structures, which can in particular be apertures, it can be achieved in a particularly effective manner that the deformation structures are loaded in torsion. By providing deformation structures that are loaded in torsion, a particularly high degree of reversible deformation capability can be provided. By providing helical deformation structures, a particularly good torsional load can be achieved. As already mentioned, several helices can also be provided so that multiple helical deformation structures can be present. In other words, the multiple helical deformation structures can be designed similar to a multi-start thread.

Advantageously, a deformation structure, in particular the spiral, has a material thickness in the direction of the direction of progression and a material thickness in the direction of the radial direction, which can also be referred to as radial thickness, wherein the ratio of the material thickness to the radial thickness is in a range from 0.8 to 1.2, preferably in a range from 0.9 to 1.1, and particularly preferably in a range from 0.97 to 1.03. The material thickness is therefore the average and/or the maximum or minimum material thickness of the deformation structure measured in the direction of progression. The radial thickness of the deformation structure is in particular the material thickness or the material thickness in the radial direction. Advantageously, the ratio of the material thickness to the radial thickness is in the range of 0.8 to 1.2. This makes it particularly easy to manufacture. If, on the other hand, the material thickness is in the range of 0.9 to 1.1, a particularly advantageous stress distribution can be achieved. If, on the other hand, the ratio is in the range of 0.97 to 1.03, an almost homogeneous stress distribution can be achieved at all edges.

Advantageously, at least one recess and/or stiffness reduction structure, preferably a plurality of recesses and/or stiffness reduction structures, is elongated. Preferably, the or at least one, preferably at least a predominant part, and particularly preferably all stiffness reduction structures and/or recesses, which are elongate-shaped, are formed as apertures. A recess/stiffness reduction structure is to be regarded as having an elongated hole shape in particular if it has a larger dimension in its main direction of extension than perpendicular thereto. In other words, an elongated recess or elongated hole can therefore be present if the length in the circumferential direction of the aperture is greater than the length of the aperture in the direction of progression. In particular, the length of the aperture and/or the recess in the radial direction is irrelevant. In other words, only the contour which the recess and/or the aperture leaves on an outer wall of the elasticity region can therefore be decisive, in particular for the elongated hole shape. Expediently, the extent of the elongated hole-shaped aperture or the elongated hole-shaped recess, in particular in the circumferential direction, is greater than in the direction of progression. Advantageously, the extent in the circumferential direction is at least 10%, preferably at least 20% and particularly preferably at least 30% greater in the direction of progression in order to be defined as elongated hole-shaped. Advantageously, the distal end areas of the elongated hole-shaped aperture or the elongated hole-shaped recess are formed by a rounding. This can reduce the occurring material stress elevation or the stress elevation factor.

Preferably, the projections of the elongate-shaped recesses or stiffness reduction structures form a closed circle in the direction of the direction of progression, in particular in the direction of progression. In other words, the projections of the elongate-shaped recesses, which could in particular be apertures, can therefore be formed in such a way that, when viewed in the direction of progression, they overlap in such a way that a complete circle or a self-contained ring is formed, wherein the center of gravity of this ring in particular lies in the direction of progression and/or the ring surrounds the direction of progression. This allows a particularly advantageous reduction in the elasticity of the elasticity region to be achieved.

Preferably, at least one stiffness reduction structure and/or recess, which is elongate hole-shaped, has a variable width in the direction of progression and/or in the longitudinal direction. The width is, in particular, the distance between the opposite walls in the direction of progression and/or in the longitudinal direction. In particular, the elongated hole or the elongated hole-shaped recess is oriented in such a way that it extends perpendicular to the direction of progression. In other words, the main direction of extension is therefore oriented perpendicular to the direction of progression and/or the longitudinal direction when projected in the radial direction. In particular, a defined stress distribution can be achieved by the variable width in the direction of progression and/or in the longitudinal direction. Advantageously, the width of the aperture or recess, which is elongate-shaped, decreases towards the center of the aperture or recess. In other words, the width of the recess can initially decrease from one distal end of the aperture or recess towards the other distal end of the recess and then increase again after passing the center between the distal ends of the recess. In this way, a particularly advantageous anticipation of the mechanical stress that occurs can be achieved. In other words, a particularly stress-adapted course can be achieved.

Advantageously, a deformation structure, in particular a deformation structure arranged between two elongate apertures, has a material thickness, in particular a maximum material thickness, in the direction of the direction of progression and a material thickness, in particular a maximum material thickness, in the direction of the radial direction, which—as already explained—can be referred to as radial thickness, wherein the ratio of the material thickness to the radial thickness is in a range from 0.7 to 1.3, preferably in a range from 0.85 to 1.15, and particularly preferably in a range from 0.9 to 1.1. The material thickness is-as already explained—in particular the averaged and/or the maximum or minimum material thickness of the deformation structure measured in the direction of progression. The radial thickness of the deformation structure is—as also already explained—in particular the material thickness or the material thickness in the radial direction. Advantageously, the ratio of the material thickness to the radial thickness is in the range of 0.7 to 1.3. This enables particularly cost-effective production, especially if the deformation structure is at least partially limited in the direction of progression by elongated holes. If, on the other hand, the material thickness is in the range of 0.85 to 1.15, a particularly low local stress concentration can be achieved, especially if the deformation structure is at least partially limited in the direction of progression by elongated apertures. If, on the other hand, the ratio is in the range of 0.9 to 1.1, a particularly good increase in elasticity can be achieved.

Advantageously, the ratio of the mean height or the maximum height of the apertures, in particular the apertures which are elongated, in the direction of progression to the diameter of the elasticity region is in a ratio of 0.045 to 0.125, preferably in a range of 0.055 to 0.0834, particularly preferably in a range of 0.06 to 0.75. The mean height or the maximum height of the apertures in the direction of progression is the width of the aperture in the direction of progression, in particular between two walls opposite each other in the direction of progression. The average height, on the other hand, is the average height of the aperture in the direction of progression between one distal end and the other distal end. The diameter of the elasticity region, on the other hand, is the diameter of the smallest possible circle that lies in a plane perpendicular to the direction of progression and that can just surround the elasticity region. If the ratio is in the range of 0.045 to 0.125, this can achieve a particularly effective reduction in elasticity. If, on the other hand, the ratio is in the range of 0.055 to 0.0834, this can result in particularly simple production.

Advantageously, the connecting means is formed in one piece. One-piece connecting means, in particular, that the material of the connecting means was joined together in a single original primary forming process. In other words, the connecting means may have been further processed after this original forming process, in particular by separating or splitting processes, such as laser cutting and/or thread cutting and/or milling or turning, but wherein no further elements have been added to the connecting means, e.g. by welding. Advantageously, however, only the actuating area, the elasticity region and the mounting area are formed in one piece with each other. Alternatively or additionally preferably, the connecting means can also result from joining further components to one another by material bonding, in particular by material bonding of the actuating area to the elasticity region and the mounting area. In addition, further elements can also be mounted on the connecting means in this material-locking connection, so that ultimately the result is a connecting means whose actuating area, elasticity region and mounting area have been joined together by material-locking joining, although further elements can be attached to the connecting means in a force-fitting and/or form-locking and/or material-locking manner. The material-locking joining is particularly advantageous in terms of manufacturing costs. The one-piece design of the connecting means and/or the actuating area with the elasticity region and the mounting area, on the other hand, results in a particularly mechanically advantageous design.

Advantageously, the actuating area is hollow, in particular hollow inside. In particular, this allows a fluid flow in the hollow area of the actuating area through the elasticity region and/or through the mounting area. As a result, the connecting means described here can be used particularly advantageously in a fuel cell. The term hollow means in particular that the entire actuating area can be hollow in the direction of progression.

Advantageously, the actuating area has a gas connection. This makes it particularly easy to achieve a gas flow from and/or into the actuating area. In particular, the gas connection can have or form a gas-tight thread and/or a hose connection.

Advantageously, a central recess is provided, which extends in the direction of progression from the actuating area over the elasticity region and can extend as far as the mounting area. Advantageously, this central recess extends from the distal end of the mounting area to a distal end of the actuating area. In other words, a central recess can extend through the connecting means in the direction of progression, in particular in order to be able to realize a fluid flow through the connecting means. Advantageously, this central recess has a constant diameter in the actuating area, in the elasticity region and/or in the mounting area. This makes it possible to achieve particularly simple and cost-effective production, which also has mechanically advantageous properties.

Expediently, the actuating area has actuating surfaces, wherein the actuating surfaces in particular have a normal in the radial direction. As a result, a torque, in particular a form-fit torque, in particular about the direction of progression, can be exerted on the connecting means in a simple manner for mounting the connecting means. By providing for the normal of the actuating surfaces to point in the radial direction, particularly cost-effective production can be achieved, which can also be easily actuated.

Advantageously one or a plurality of recesses and/or apertures, in particular recesses and/or apertures that form spirals and/or are shaped like elongated holes, is/are laser-cut. This results in particularly cost-effective and precise production, so that local (unwanted) stress concentrations can be avoided and/or reduced.

A further aspect of the invention may relate to a use of a connecting means in/for a fuel cell as described above and/or below.

A further aspect of the invention may relate to a use of a bipolar plate and/or a bipolar plate system as described above or below in/for a fuel cell as described above and/or below.

An additional aspect of the invention may relate to a use of an end plate as described above or below in/for a fuel cell as described above and/or below.

Expediently, the fuel cell comprises at least one bipolar plate, preferably a plurality of bipolar plates, in particular as described above and/or below. Alternatively or additionally preferably, the fuel cell may also comprise one or a plurality of connecting means and/or sealing elements, in particular as described above and/or below. Further alternatively or additionally preferably, the fuel cell may also comprise at least one end plate or two end plates, in particular as described above and/or below.

In a preferred embodiment of a fuel cell, a cavity is formed between and/or in two bipolar plates, which cavity is partially bounded by the flow region of one or both bipolar plates, wherein a fluid enters or can enter the cavity through one of the apertures, in particular through a flow aperture, of the bipolar plate and/or wherein a fluid enters or can exit the cavity through one of the apertures, in particular through a flow aperture, of the bipolar plate. In other words, the flow region of the bipolar plate can therefore be in fluid connection with a flow aperture of one aperture and a flow aperture of another aperture. This can create a particularly effective and simple way of bringing fluids into contact with the flow region via the flow apertures.

In a preferred further development, an MEA is arranged in the cavity. An MEA is understood to be a membrane electrode unit. This allows a particularly compact design of the fuel cell to be achieved.

A further aspect of the invention may relate to a method of manufacturing a connecting means, in particular as described above and below. In particular, the method comprises the steps of:
Advantageously providing a blank;
Shaping of an actuating area, in particular a head, advantageously by forming:
Shaping of a mounting area, in particular a hollow one, in particular by forming:
Shaping of an elasticity region, in particular by introducing stiffness reduction structures, advantageously in the form of recesses and/or apertures, in the direction of progression between the actuating area and the mounting area.

The insertion of the stiffness reduction structures can be carried out in particular by means of a laser, for example by laser cutting. The connecting means provided by the manufacturing method may in particular have the features, configurations, embodiments and advantages set out above and below. In particular, the shaping of the actuating area and/or the shaping of the elasticity region and/or the shaping of the mounting area is carried out by a forming process in order to achieve a particularly mechanically resilient and yet cost-effective design of a connecting means. In particular, the connecting means can be a screw and/or a bolt.

### BRIEF DESCRIPTION OF THE DRAWINGS

Further advantages and features of the present invention are shown in the following description with reference to the figures. Individual features of the embodiments shown can also be used in other embodiments, unless this has been expressly excluded.

It shows:

FIG. 1 a bipolar plate:

FIG. 2 a fuel cell and/or a bipolar plate:

FIG. 3 a view of an alternative design of a bipolar plate:

FIG. 4 a fuel cell with a bipolar plate and a connecting means:

FIG. 5 a fuel cell with an end plate and a plurality of bipolar plates:

FIG. 6is an isometric view of an end plate:

FIG. 7 a side view of a connecting means with stiffness reduction structures in elongated hole form:

FIG. 8 also a connecting means with stiffness reduction structures as a recess, whereby the width of the stiffness reduction structures decreases towards the center:

FIG. 9 a partial view of a connecting means in a fuel cell:

FIG. 10 a plurality of connecting means in a fuel cell:

FIG. 11 a side and sectional view of a connecting means: and

FIG. 12a connecting means with a deformation structure, which is a spiral.

### DETAILED DESCRIPTION

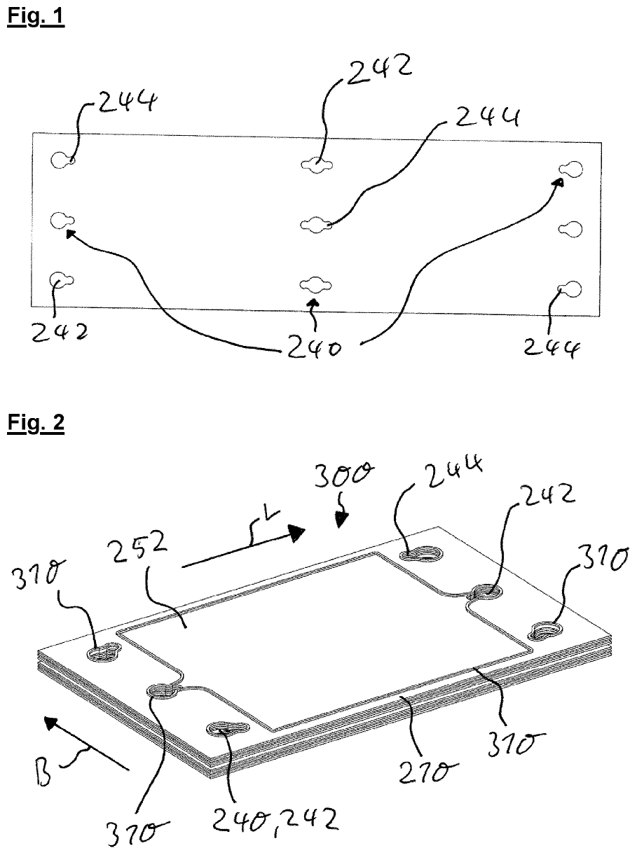

FIG. 1 shows an isometric view of a bipolar plate 210. The bipolar plate 210 has a plurality of apertures 240 which extend in the height direction H. The apertures 240 each comprise a mounting aperture 242 and a flow aperture 244. The mounting aperture 242 each has a circular segment-shaped portion and/or forms a circular segment-shaped portion of the outer contour of the aperture 240. The mounting aperture 242 is configured to receive a connecting means, the bipolar plate has a width-to-length ratio of less than or equal to 1 to 3, wherein a plurality of apertures 240 are arranged in the bipolar plate 210 in the center region in the longitudinal direction L. As a result, a particularly homogeneous distribution of tensioning force can be formed on the bipolar plate 210.

FIG. 2 shows an isometric view of bipolar plates 210, which are arranged one above the other in the height direction H. A sealing element 310 is arranged between each of the bipolar plates 210. In other words, FIG. 2 also shows a bipolar plate system 300, which may comprise a bipolar plate 210 and a sealing element 310. The bipolar plate system is thereby a part of the invention and can be used in a bipolar plate according to the invention. This circumstance is independent of the embodiment. As can be seen from the bipolar plate 210, which is highest in the height direction H, a plurality of sealing elements 310 are fixed on it. These sealing elements 310 each surround an aperture 240. Each of the apertures 240 comprises at least one mounting aperture 242 and one flow aperture 244. The sealing element 310 follows at least 60% of the circular segment-shaped part of the outer contour of each aperture 240. The circular segment-shaped part of the mounting aperture 242 forms at least 65% of a circle of the respective apertures 240. The flow apertures 244 are formed in such a way that they point towards the flow region 252. The flow region 252 is also surrounded by a sealing element 310. Each sealing element 310 projects at least partially into an aperture 240 or two apertures 240, namely at least partially into the mounting aperture 242. This can create a particularly good insulation option for a connecting means 9, which can be accommodated in the mounting aperture 244, as shown, for example, in FIG. 4.

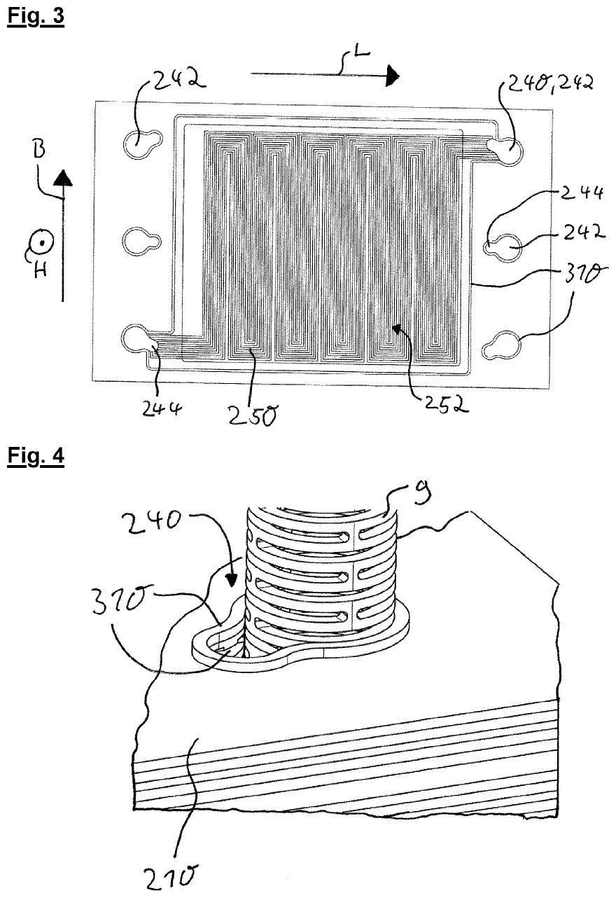

FIG. 3 shows a view of a bipolar plate 210, wherein the bipolar plate 210 has six apertures 240 extending in the height direction H. The width direction B and the longitudinal direction L are perpendicular to the height direction H. The flow grooves 250, which lead through the flow region 252, extend from the aperture 240 arranged at the bottom left to the aperture 240 arranged at the top right. The flow grooves 250 are arranged in a meandering pattern.

The flow region 252 is surrounded by the sealing element 310, which also surrounds two apertures 240.

FIG. 4 shows a fuel cell 1 or a part of a fuel cell 1, in particular a bipolar plate system 300, comprising a plurality of sealing elements 310 and a plurality of bipolar plates 210 as well as a connecting means 9. The connecting means 9 extends in the height direction H. As can be seen from FIG. 4, a plurality of sealing elements 310 contact the bipolar plate 210 and the connecting means 9. The connecting means 9 is designed such that it has a flow passage extending in the height direction H, wherein the flow passage is in fluid connection with the flow aperture 244 of the respective apertures 240. This enables a particularly good and advantageous fluid supply and/or discharge through the connecting means 9.

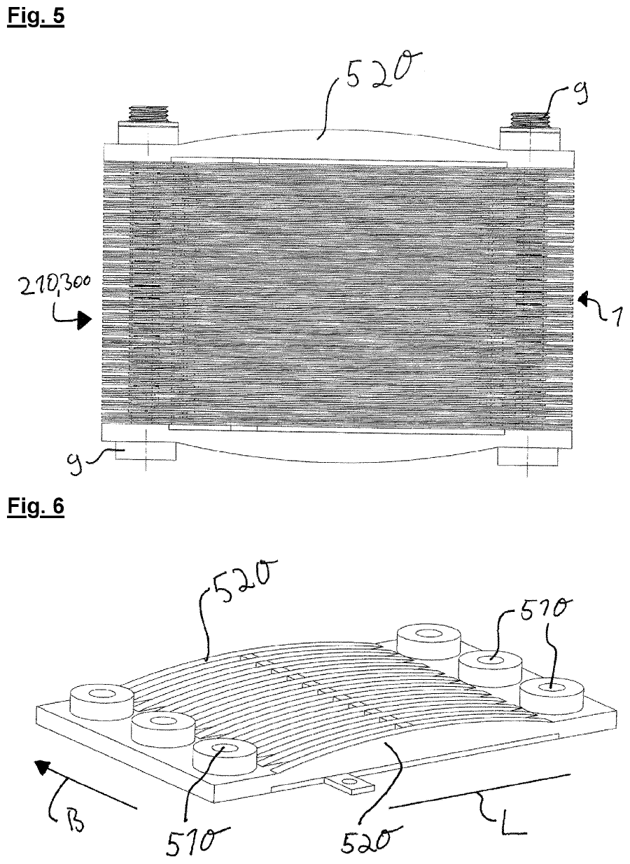

FIG. 5 shows a fuel cell 1, wherein the fuel cell 1 has a plurality of connecting means 9 and a plurality of bipolar plates 210 and/or bipolar plate systems 300. The fuel cell 1 is bounded in the height direction H at least in sections by an end plate 500.

FIG. 6 shows an end plate 500. The end plate 500 extends in the longitudinal direction L and in the width direction B, wherein the end plate 500 has tensioning areas 502 spaced apart from one another in the longitudinal direction L, wherein fastening apertures 510 are arranged in the tensioning areas 502. The tensioning areas 502 are arranged in such a way that they each have at least three fastening apertures 510. Between the tensioning areas 502, in particular viewed in the longitudinal direction L, the bending stiffness of the end plate 500 is variable, wherein this decreases in the direction towards the tensioning areas 502. This variable bending stiffness can be achieved by the stiffening ribs 520, which extend parallel to the longitudinal direction L.

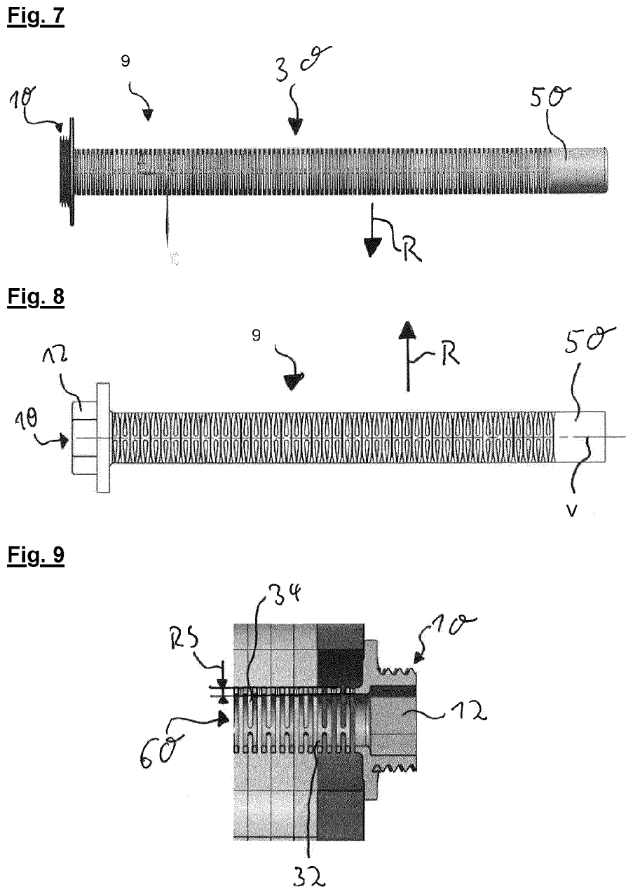

FIG. 7 shows a connecting means 9, which has an actuating area 10 in the form of a head. The actuating area 10 has a connection thread for a gas connector. In addition, the connecting means 9 also has a mounting area 50, wherein the fastening area 10 and the mounting area 50 form distally opposite end areas of the fastening means/connecting means 9 in the direction of progression V. The elasticity region 30 is located between the fastening area 10 and the mounting area 50. Due to its geometry, the elasticity region 30 has a lower elasticity than the mounting area 50 and than the actuating area 10, and wherein the elasticity region 30 has a degressive spring characteristic. These stiffness characteristics of the elasticity region 30 are achieved by the elongated hole-shaped stiffness reduction structures, which are formed as an aperture.

FIG. 8 shows a similar fastening means/connecting means 9 compared to FIG. 7. However, the actuating area 10 has an external hexagon with actuating surfaces 12. In the mounting area 50, which is hollow on the inside, there is an internal thread for mounting. The radial direction R points radially from the direction of progression V. The deformation structures 32 present in the elasticity region 30 are such that they have a variable width in the direction of progression V, with the width decreasing towards the center of the recess.

FIG. 9 shows a detailed view of a mounted connecting means 9 in a fuel point. Both the actuating area 10, which has actuating surfaces 12 in its interior, and the elasticity region 30 are provided with a central recess 60, resulting in an internally hollow area both in the elasticity region 30 and in the actuating area 10. The stiffness reduction structures are formed in an elongated hole shape. The stiffness reduction structures 34 form the deformation structures 32, wherein the deformation structures 32 have a radial thickness RS in the radial direction R.

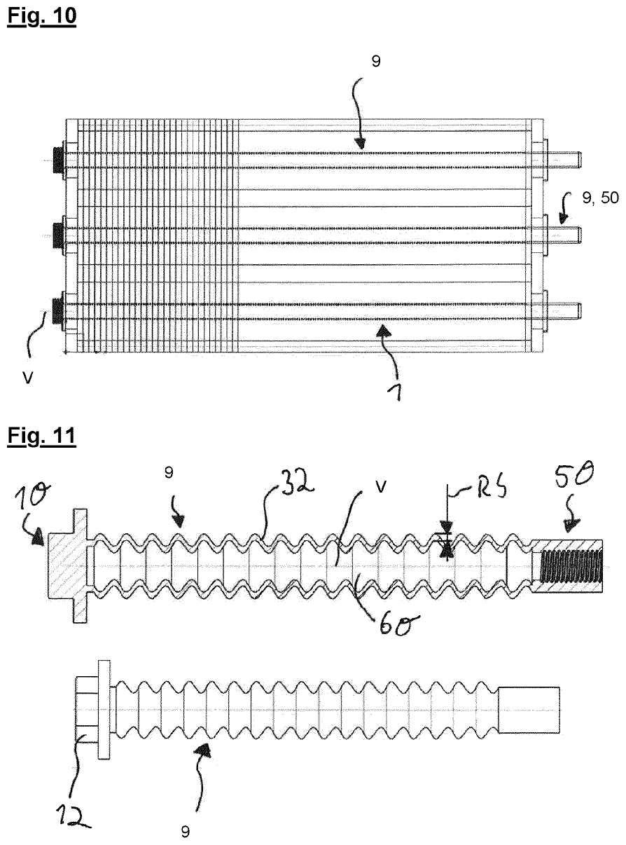

FIG. 10 shows a fuel cell that has a large number of connecting means 9. The connecting means 9 completely penetrate the fuel cell 9 in the direction of progression V or in the height direction H. Basically, the connecting means 9 or the direction of progression V should be parallel to the longitudinal direction L or the height direction H.

FIG. 11 shows a side view in the lower area and a sectional view through a connecting means 9 in the upper area. The connecting means 9 extends in the direction of progression V. In the elasticity region 32, plate spring-like deformation structures 32 are formed in series. Due to this geometric design, the elasticity region 30 has a degressive spring characteristic. The radial thickness RS in the elasticity region is recognizable. Both the mounting area 50 and the elasticity region 30 are hollow on the inside and therefore each have a section of the central recess 60. In order to achieve mounting of the connecting means 9, the mounting area 50 has an internal thread.

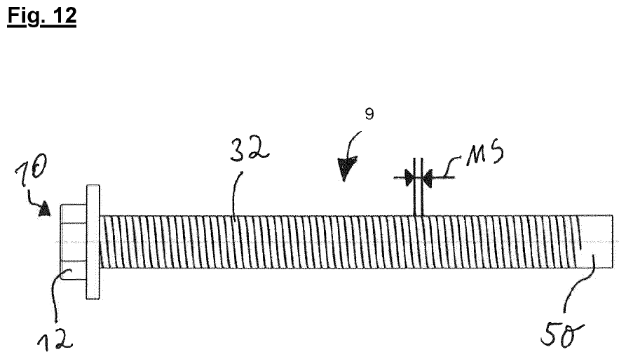

FIG. 12 shows a connecting means 9. The connecting means 9 has a deformation

structure 32, which is a spiral. In other words, the elasticity region 30 has a helical depression that forms the deformation structure 32. The deformation structure 32 has a material thickness MS in the direction of progression V. Alternatively, instead of a helical depression, a plurality of helical depressions can also be provided, resulting in a multi-threaded deformation structure or deformation structures in the form of a spiral. The mounting area 50 also has a metric internal thread.

### LIST OF REFERENCE SIGNS

1—Fuel cell
9—Connecting means
10—Actuating area, especially head
12—Actuating surface
30—Elasticity region
32—Deformation structures
34—Stiffness reduction structures, depressions, especially apertures
50—Mounting area
60—Central recess
210—Bipolar plate
240—Aperture
242—Mounting aperture
244—Flow aperture
250—Flow groove
252—Flow region
300—Bipolar plate system
310—Sealing clement
500—End plate
502—Tensioning area
510—Fastening apertures
520—Stiffening ribs
B—Width direction
L—Longitudinal direction
H—Height direction
V—Direction of progression
MS—Material thickness
R—Radial direction
RS—Radial thickness
U—Circumferential direction

1. A fuel cell comprising:
a bipolar plate comprising a connecting means,
wherein the bipolar plate extends in a longitudinal direction and in a width direction,
wherein the longitudinal direction and the width direction are perpendicular to each other,
wherein the bipolar plate has a plurality of apertures,
wherein the apertures have an outer contour,
wherein the outer contour of the apertures is formed in each case by a mounting aperture and at least one flow aperture,
wherein the mounting aperture forms a circular segment-shaped part of the outer contour of the aperture,
wherein the mounting aperture is designed to receive the a connecting means,
wherein the connecting means comprises an actuating area a head, an elasticity region, and a mounting area,
wherein the connecting means extends in a direction of progression,
wherein a radial direction is perpendicular to the direction of progression,
wherein the elasticity region lies between the actuating area and the mounting area in the direction of progression,
wherein the mounting area has a thread,
wherein the elasticity region and/or the mounting area are hollow,
wherein the elasticity region has stiffness reduction structures,
wherein the elasticity region has a lower elasticity than the mounting area and/or than the actuating area due to its geometry, and
wherein the elasticity region has a degressive spring characteristic.

2. The fuel cell according to claim 1, wherein the circular segment-shaped part of the mounting aperture forms at least 51%, preferably at least 65% and particularly strongly preferred at least 75% of a circle.

3. The fuel cell according to claim 1, wherein the circular segment-shaped part of the mounting aperture forms a maximum of 98%, preferably a maximum of 90%, and particularly preferably a maximum of 80%, of a circle.

4. The fuel cell according to claim 1, further comprising and a sealing element,
wherein the sealing element is in contact with the bipolar plate, and
wherein the sealing element follows at least in sections the circular segment-shaped part of the outer contour of an aperture.

5. The fuel cell according to claim 4, wherein the sealing element projects into the aperture.

6. The fuel cell according to claim 4, wherein the sealing element is fixed to the bipolar plate, and
wherein the sealing element is produced by a screen-printing process or by a mold-in place process.

7. The fuel cell according to claim 4, wherein the sealing element is arranged on the bipolar plate in such a way that the sealing element forms a closed contour on the bipolar plate, wherein at least two flow apertures and/or the flow region of the bipolar plate are arranged within the closed contour.

8. The fuel cell according to claim 7, wherein the elasticity region has one or a plurality of deformation structures which are subjected to bending and/or torsion when the actuating area is displaced in the direction of progression in relation to the mounting area.

9. The fuel cell according to claim 7, whereby the elasticity region has a degressive spring characteristic.

10. The fuel cell according to claim 7,
wherein at least one depression is elongate.

11. The fuel cell according to claim 7,
wherein a central recess is present, which extends in the direction of progression from the actuating area via the elasticity region to the mounting area.

12. The fuel cell according to claim 1, wherein the connecting means is guided through the aperture, and
wherein the connecting means contacts the sealing element.

13. The fuel cell according to claim 12, wherein the connecting means has a flow passage extending along a height direction and/or a central recess, and
wherein the flow passage and/or the central recess is in fluid communication with the flow aperture, which co-forms the aperture through which the connecting means is guided.

14. Use of a bipolar plate and/or a bipolar plate system in a fuel cell according to claim 1.

15. (canceled)
